(19) United States
(12) Patent Application Publication
(10) Pub. No.: US 2013/0088847 A1
(43) Pub. Date: Apr. 11, 2013

(54) LIGHT-GUIDING SHEET AND MOVABLE CONTACT BODY USING SAME

(71) Applicant: Naoki Tatehata, Kyoto (JP)

(72) Inventor: Naoki Tatehata, Kyoto (JP)

(73) Assignee: PANASONIC CORPORATION, Osaka (JP)

(21) Appl. No.: 13/704,563

(22) PCT Filed: Jul. 15, 2011
(86) PCT No.: PCT/JP2011/004041

§ 371 Date: Dec. 14, 2012

(30) Foreign Application Priority Data
Jul. 22, 2010 (JP) 2010-164559
Jun. 15, 2011 (JP) 2011-132976

(51) Int. Cl. F21V 8/00; H01H 13/02

(52) U.S. Cl. CPC G02B 6/0001; H01H 13/023
USPC 362/23.05; 362/606

(57) ABSTRACT

A light-guiding sheet includes a film-shaped light-transmitting base material, a plurality of light-emitting portions formed on the base material, and a light-transmitting light-guiding layer covering the plurality of light-emitting portions. With this configuration, light enters the light-emitting portion from the base material and the light-guiding layer, thereby increasing an amount of light scattered and reflected by the light-emitting portions. Therefore, a movable contact body using the light-guiding sheet enables bright illumination, thus enabling easy-to-see and easy operation.

### TECHNICAL FIELD

The present invention relates to a light-guiding sheet used in operations of various electronic apparatuses and a movable contact body using the same.

### BACKGROUND ART

Recently, an increasing number of electronic apparatuses have been provided with a light emitting diode, an EL (Electro Luminescent) element or the like so as to illuminate an operation portion. This configuration enables a user to easily recognize and operate a pushbutton, a display sheet, or the like, even in dark surroundings. Examples of such electronic apparatuses include portable terminal equipment such as a mobile telephone and an electronic camera. Furthermore, movable contact bodies and switches used for such electronic apparatuses are also required to provide bright and easy-to-see illumination.

FIG. 7 is a sectional view of a conventional switch. FIG. 7 is shown with an expanded scale partially for an easy understanding of configuration.

A plurality of convex light-emitting portions 2 are provided on predetermined positions of the lower surface of film-shaped light-transmitting base material 1. Thus, light-guiding sheet 3 is formed.

Film-shaped base sheet 4 is attached on the lower surface of light-guiding sheet 3 with an adhesive (not shown) at a predetermined part of the outer periphery thereof. A plurality of movable contacts 5 are attached on the lower surface of base sheet 4 below light-emitting portions 2. Movable contact 5 is formed of a dome-shaped thin metal plate. As mentioned above, movable contact body 6 is configured.

A plurality of wiring patterns (not shown) are formed on the upper and lower surfaces of wiring board 7. Furthermore, a plurality of fixed contacts 8 composed of center fixed contacts 8A and outer fixed contacts 8B are provided on the upper surface of wiring board 7. Center fixed contact 8A is formed in a circular shape. Outer fixed contact 8B is formed in a horseshoe shape or a ring shape such that it surrounds center fixed contact 8A.

The outer periphery of movable contact 5 is placed on outer fixed contact 8B. Movable contact body 6 is attached on the upper surface of wiring board 7 such that the center of the lower surface of movable contact 5 faces center fixed contact 8A with a predetermined space therebetween.

Light-emitting element 9 formed of, for example, a light-emitting diode is mounted on the upper surface of wiring board 7 at the side part of light-guiding sheet 3 in such a manner that a light-emitting surface of light-emitting element 9a faces an end surface of base material 1.

Coated portion 10A is formed on the lower surface of film-shaped light-transmitting display sheet 10 by, for example, printing. Predetermined parts of coated portion 10A are punched out in shapes of characters, symbols, or the like, thereby forming a plurality of display portions 10B. Display portions 10B are disposed above a plurality of light-emitting portions 2 of light-guiding sheet 3. As mentioned above, a switch is configured.

The switch thus configured is installed on an operation surface (not shown) of an electronic apparatus such as a mobile telephone. Furthermore, a plurality of center fixed contacts 8A and outer fixed contacts 8B, and light⁻emitting element 9 are connected to an electronic circuit (not shown) of an electronic apparatus via wiring patterns, and the like.

When display sheet 10 is pressed downward by predetermined display portions 10B, light-guiding sheet 3 and base sheet 4 disposed below bend, so that the center part of dome-shaped movable contact 5 is pressed. When a predetermined pressing force is applied, movable contact 5 is elastically reversed downward with a click feeling, so that the center of the lower surface of movable contact 5 is brought into contact with center fixed contact 8A. Thus, center fixed contact 8A and outer fixed contact 8B are electrically connected to each other via movable contact 5.

When the pressing force applied to display sheet 10 is released, movable contact 5 is elastically reversed upward by an elastic returning force. As a result, the center of the lower surface of movable contact 5 departs from center fixed contact 8A, so that center fixed contact 8A and outer fixed contact 8B are electrically disconnected from each other.

In response to such electrical connection/disconnection of fixed contact 8, various functions of the electronic apparatus are switched. When electric power is supplied to light emitting element 9 from an electronic circuit of the electronic apparatus, light-emitting element 9 emits light. The light enters the inside of light-guiding sheet 3 from the end surface, and proceeds to the inner part while it is reflected in base material 1.

Furthermore, the light is scattered or reflected by a plurality of light-emitting portions 2 on the lower surface of base material 1, and illuminates display portion 10B of display sheet 10 from below. When a plurality of display portions 10B are illuminated, a user can recognize displays such as characters or symbols on display portions 10B even in dark surroundings, so that a user can operate display portions 10B easily.

That is to say, when display sheet 10 is pressed, the upper surface of light-guiding sheet 3 is pressed, movable contact 5 is elastically reversed, and electrical connection/disconnection of a plurality of fixed contacts 8 can be carried out. Furthermore, the light from light-emitting element 9 is introduced into the inside of light-guiding sheet 3 from the end surface, and a plurality of light-emitting portions 2 are allowed to emit light. Thereby, the light illuminates a plurality of display portions 10B of display sheet 10.

As prior art literatures relating to the present application, for example, Patent Literature 1 is known.

However, when light-emitting element 9 is disposed distant from light-guiding sheet 3, an amount of light which enters the inside of light-emitting portion 2 and is scattered may be small. Therefore, the intensity for illuminating display portion 10B is lowered, and display portion 10B may be somewhat dark.

### CITATION LIST

### Patent Literature

PTL 1: Japanese Patent Unexamined Publication No. 2009-187925

### SUMMARY OF THE INVENTION

A light-guiding sheet includes a film-shaped light-transmitting base material, a plurality of light-emitting portions formed on the base material, and a light-transmitting light-guiding layer covering the plurality of light-emitting portions. With this configuration, since light enters the light-emitting portions from the base material and the light-guiding layer, an amount of light scattered and reflected by the light-emitting portions is increased. Therefore, a movable contact body using the light-guiding sheet enables bright illumination, thereby enabling easy-to-see and easy operation.

### BRIEF DESCRIPTION OF THE DRAWINGS

FIG. 1 is a sectional view of a movable contact body in accordance with an exemplary embodiment of the present invention.

FIG. 2 is a sectional view of a switch using the movable contact body shown in FIG. 1.

FIG. 3A is a schematic view showing a state in which light in a light-guiding sheet is scattered in accordance with the exemplary embodiment of the present invention.

FIG. 3B is a schematic view showing a state in which light in a light-guiding sheet is scattered in accordance with the exemplary embodiment of the present invention.

FIG. 4 is a schematic view of another light-guiding sheet in accordance with the exemplary embodiment of the present invention.

FIG. 5 is a schematic top view of a switch in accordance with the exemplary embodiment of the present invention.

FIG. 6 is a schematic top view of another switch in accordance with the exemplary embodiment of the present invention.

FIG. 7 is a sectional view of a conventional switch.

### DETAILED DESCRIPTION OF THE PREFERRED EMBODIMENT

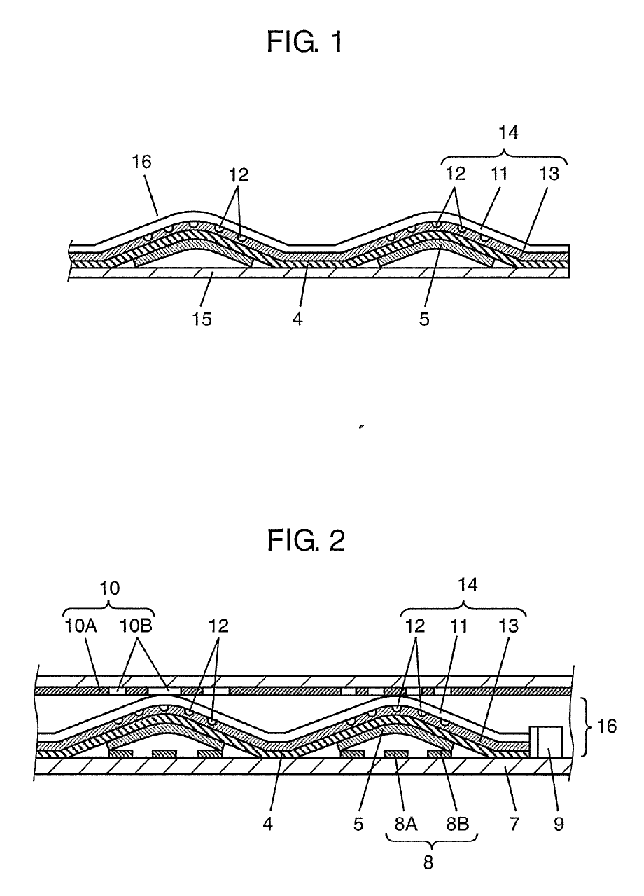

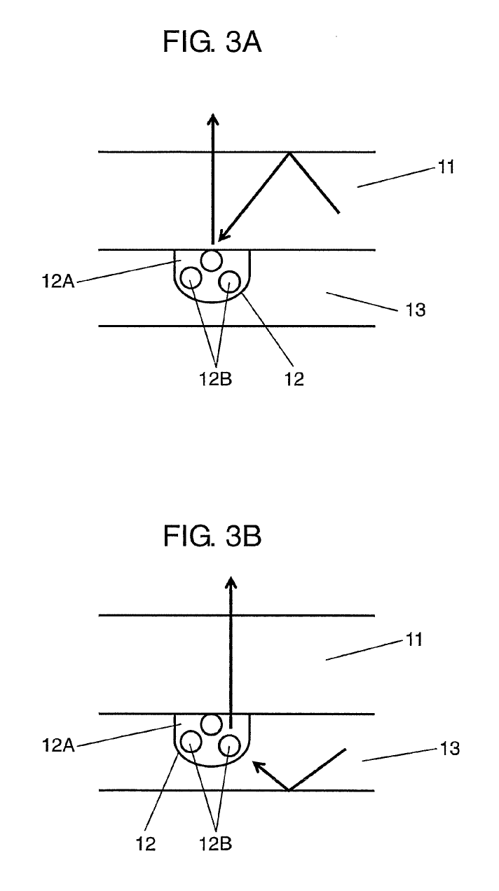

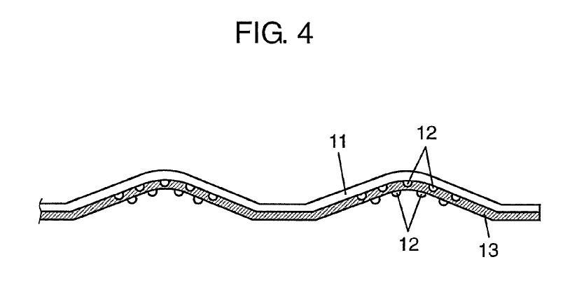

FIG. 1 is a sectional view of a movable contact body in accordance with an exemplary embodiment of the present invention. FIG. 2 is a sectional view of a switch using the movable contact body shown in FIG. 1. FIGS. 3A and 3B are a schematic view showing a state in which light in a light-guiding sheet is scattered in accordance with the exemplary embodiment of the present invention. FIG. 4 is a schematic view of another light-guiding sheet in accordance with the exemplary embodiment of the present invention. Note here that these drawings are shown with an expanded scale partially for an easy understanding of configurations.

Light-guiding sheet 14 includes film-shaped light-transmitting base material 11, a plurality of light-emitting portions 12 formed on base material 11, and light-transmitting light-guiding layer 13 covering the plurality of light-emitting portions 12. In the configurations shown in FIGS. 1 and 2, light-emitting portions 12 are formed on the lower surface of base material 11.

Film-shaped flexible light-transmitting base material 11 having a thickness of about 0.15 mm is formed of urethane, acryl, or the like, having a light refractive index of about not less than 1.50 and not more than 1.51.

Furthermore, the plurality of light-emitting portions 12 each having a diameter of about not less than 0.05 mm and not more than 0.5 mm, and a height of about not less than 0.005 mm and not more than 0.02 mm, are provided in a dot shape in predetermined positions on the lower surface of base material 11 by, for example, printing.

As shown in FIG. 3A, light-emitting portion 12 includes about not less than 5 weight % and not more than 70 weight % of white or milk white inorganic oxide particles 12B dispersed in synthetic resin 12A such as polyester, acrylic, and epoxy resin. Examples of inorganic oxide particles 12B include titanium oxide having a refractive index of about 2.7, barium titanate having a refractive index of about 2.4, and zinc oxide having a refractive index of about 2.0, and the like, which have a particle diameter of about not less than 0.1 μm and not more than 5 μm.

It is preferable that the diameter of inorganic oxide particles 12B dispersed in synthetic resin 12A is not less than 0.4 μm and not more than 0.8 μm, which is substantially the same as the wavelength of visible light, or not less than 0.4 μm and not more than 1.5 μm, which is somewhat larger than the wavelength. Furthermore, an amount of inorganic oxide particles 12B dispersed into synthetic resin 12A is preferably not less than 10 weight % and not more than 40 weight %, which facilitates formation by, for example, printing.

Light-transmitting light-guiding layer 13 is formed of acryl, urethane acrylate and the like, having a thickness of about 0.05 mm, and having a refractive index of about not less than 1.49 and not more than 1.51, which is substantially the same as or somewhat lower than that of base material 11. Light-guiding layer 13, which is formed on the lower surface of base material 11 by, for example, printing, covers the plurality of light-emitting portions 12. Thereby, light-guiding sheet 14 is configured.

Light-guiding layer 13 is formed by using a screen printing method as mentioned below. That is to say, resin materials such as acryl and urethane acrylate are made into a fluid paste state. Then, the paste is print-formed by a screen printing method on the surface at light-emitting portion 12 side of base material 11 so as to cover the plurality of light-emitting portions 12, followed by hardening thereof. In printing, when the viscosity of the paste is made to be not less than 1 Pa·s and not more than 20 Pa·s, the plurality of light-emitting portions 12 can be made into a state in which they are excellently covered with the paste. It is further preferable that the viscosity is made to be not less than 5 Pa·s and not more than 10 Pa·s because it is possible to secure the printing thickness and reduce blurred printing and the like. Note here that light-guiding layer 13 may be formed by methods other than the screen printing method.

Base sheet 4 is formed in a film shape having flexibility, and formed of polyethylene terephthalate, polycarbonate, or the like. Movable contact 5 is formed in a dome shape and formed of a thin metal plate of, for example, a copper alloy and steel.

Base sheet 4 is attached on the lower surface of light-guiding sheet 14 with an adhesive (not shown) such as acryl and silicone at predetermined positions on the outer periphery. Furthermore, a plurality of movable contacts 5 are attached on the lower surface of base sheet 4 below light-emitting portions 12. Thus, movable contact body 16 is configured.

Separator 15 is formed of a film-shaped polyethylene terephthalate and the like. Separator 15 is attached so as to cover the entire surface of the lower surface of base sheet 4, which prevents dust and the like from adhering to the lower surface of movable contact 5 during storage and transportation.

FIG. 2 is a sectional view of a switch using movable contact body 16, and wiring board 7 is formed in a film shape of polyethylene terephthalate, polycarbonate, or the like, or formed in a plate shape of paper phenol, glass epoxy, or the like. A plurality of wiring patterns (not shown) made of copper and the like are formed on the upper and lower surfaces of wiring board 7.

On the upper surface of wiring board 7, a plurality of fixed contacts 8 are provided. Fixed contacts 8 include circular-shaped center fixed contact 8A and horseshoe-shaped or ring-shaped outer fixed contact 8B surrounding center fixed contact 8A, which are formed of copper, carbon, or the like.

Movable contact body 16 from which separator 15 has been exfoliated is attached on the upper surface of wiring board 7 such that outer periphery of each of movable contacts 5 is placed on outer fixed contact 8B, and the center of the lower surface of movable contact 5 faces center fixed contact 8A with a predetermined space therebetween.

Light emitting element 9 formed of, for example, a light emitting diode is mounted on the upper surface of wiring board 7 at the side part of light-guiding sheet 14 such that a light-emitting surface of light emitting element 9 faces the end surfaces of base material 11 and light-guiding layer 13.

On the lower surface of film-shaped light-transmitting display sheet 10, coated portion 10A is formed by, for example, printing. A plurality of display portions 10B are formed by punching predetermined parts of coated portion 10A in shapes of, for example, characters and symbols. Display portions 10B are disposed above the plurality of light emitting portions 12.

The switch thus configured is installed in an operation surface of electronic apparatuses (not shown) such as a mobile telephone. A plurality of center fixed contacts 8A, outer fixed contacts 8B, and light-emitting element 9 are connected to an electronic circuit (not shown) of the electronic apparatus via wiring patterns, and the like.

When a predetermined display portion 10B of display sheet 10 is pressed downward, light-guiding sheet 14 and base sheet 4 below the pressed portion bend, so that a center part of dome-shaped movable contact 5 is pressed. When a predetermined pressing force is applied, movable contact 5 is elastically reversed downward with a click feeling, so that the center of the lower surface of movable contact 5 is brought into contact with center fixed contact 8A. As a result, center fixed contact 8A and outer fixed contact 8B are electrically connected to each other via movable contact 5.

Furthermore, when the pressing force applied to display sheet 10 is released, movable contact 5 is elastically reversed upward by an elastic returning force. As a result, the center of the lower surface of movable contact 5 departs from center fixed contact 8A, and center fixed contact 8A and outer fixed contact 8B are electrically disconnected from each other.

In response to the electrical connection/disconnection of fixed contacts 8, various functions of the electronic apparatus are switched. When electric power is supplied to light emitting element 9 from an electronic circuit of the electronic apparatus, light-emitting element 9 emits light, and the light enters the inside of light-guiding sheet 14 from the end surface and moves to the inner part while it is reflected in base material 11 and light-guiding layer 13.

Furthermore, the light is scattered or reflected by inorganic oxide particles 12B in a plurality of light-emitting portions 12 covered with light-guiding layer 13 provided on the lower surface of base material 11, thereby illuminating display portion 10B of display sheet 10 provided above inorganic oxide particles 12B from the lower side. When a plurality of display portions 10B are illuminated, a user can recognize displays such as characters, symbols, or the like, on display portions 10B, and the user can carry out operations easily even in dark surroundings.

That is to say, when display sheet 10 is pressed, the upper surface of light-guiding sheet 14 is pressed, movable contact 5 is elastically reversed and a plurality of fixed contacts 8 are electrically connected/disconnected. The light of light-emitting element 9 is introduced from the end surface into base material 11 and light-guiding layer 13 of light-guiding sheet 14 so as to illuminate a plurality of light-emitting portions 12. Thereby, a plurality of display portions 10B of display sheet 10 are illuminated.

As shown in FIG. 3A, light of light-emitting element 9 from the end surface of base material 11 enters light-emitting portion 12, and the light is scattered or reflected by a plurality of inorganic oxide particles 12B, so that illumination is carried out. Furthermore, as shown in FIG. 3B, light from the end surface of light-guiding layer 13 is similarly scattered or reflected by light-emitting portion 12, so that display portion 10B disposed above is illuminated.

That is to say, light-guiding layer 13 having a refractive index that is substantially the same as or somewhat lower than that of base material 11 is provided so as to sandwich a plurality of light-emitting portions 12 formed on the lower surface of base material 11. Then, the light of light-emitting element 9 is allowed to enter light-emitting portion 12 from base material 11 disposed at the upper side of light-emitting portions 12 and from light-guiding layer 13 that covers the lower side of light-emitting portions 12, and thus, light-emitting portions 12 are allowed to emit light by the above-mentioned both light. As a result, an amount of illuminated light is increased, and, therefore, display portion 10B is illuminated brightly.

Furthermore, when light-emitting portions 12 are formed in a middle portion between base material 11 and light-guiding layer 13, light-emitting portion 12 can emit light more brightly with a larger amount of light as compared with a case in which light-emitting portions 12 are formed on the upper surface or the lower surface of the base material when the entire thickness is equal, for example, about 0.2 mm.

That is to say, in general, light propagates at a higher rate in the vicinity of the middle portion as compared with the upper surface or the lower surface with respect to the thickness direction of a substance through which the light is guided. In this configuration, the light of light-emitting element 9 propagates within the thickness that is total thickness of base material 11 and light-guiding layer 13. Therefore, when light-emitting portion 12 is located in the middle portion between base material 11 and light-guiding layer 13 as in this configuration, light-emitting portion 12 emits light more brightly as compared with a case in which light-emitting portion 12 is provided on the upper surface or the lower surface of light-guiding sheet 14.

Furthermore, in this configuration, in a case where base material 11 and light-guiding layer 13 have substantially the same optical characteristics, that is, have substantially the same refractive index, substantially the same light transmittance, substantially the same transparency, and the like, light-emitting portion 12 can emit light more brightly when base material 11 and light-guiding layer 13 have the same thickness.

However, as mentioned above, when light⁻guiding layer 13 is formed by using, for example, a screen printing method, in general, in many cases, the light transmittance or transparency is slightly lower in light-guiding layer 13 than in base material 11. In such a case, when the thickness of light-guiding layer 13 is made to be thinner than that of base material 11 such that a larger amount of light is guided to base material 11 side, light-emitting portion 12 can emit light more brightly. When light-guiding layer 13 is formed thinner than base material 11, light-guiding layer 13 can be formed with good workability even when a screen printing method is used.

According to this exemplary embodiment, as mentioned above, the thickness of base material 11 is made be 0.15 mm and the thickness of light-guiding layer 13 is made to be 0.05 mm. That is to say, the thickness of light-guiding layer 13 is made to be somewhat thinner than that of material 11. Therefore, a light-guiding sheet whose light-emitting portion 12 emits light brightly can be produced with good workability.

As is apparent from the description above, when light-guiding layer 13 is formed to have a refractive index that is substantially the same as or somewhat lower than a refractive index of base material 11, light of light-emitting element 9, which enters from the end surfaces of base material 11 and light-guiding layer 13, is introduced into a plurality of light-emitting portions 12 efficiently, and thus, light-emitting portions 12 can be allowed to emit light with high intensity.

Note here that when the refractive index of base material 11 and the refractive index of light-guiding layer 13 are different from each other, light enters from the side having a lower refractive index enters to the side having a higher refractive index, and light in any one of base material 11 and light-guiding layer 13 is increased and light of the other one is reduced. However, such a leakage of light is prevented by making the refractive index of base material 11 and that of light-guiding layer 13 substantially the same as each other. Thus, a large amount of light can be allowed to enter light-emitting portion 12 both from base material 11 and light-guiding layer 13. However, when the light transmittance of base material 11 is higher than that of light-guiding layer 13, the refractive index of light-guiding layer 13 may be somewhat lower than the refractive index of base material 11.

Furthermore, in order to introduce a larger amount of light into light-emitting portion 12 from base material 11 and light-guiding layer 13, it is preferable that the refractive index of synthetic resin 12A of light-emitting portion 12 is made to be substantially the same as or somewhat higher than the refractive indices of base material 11 and light-guiding layer 13. For example, when urethane having a refractive index of 1.51 is used for base material 11, and acryl having a refractive index of 1.50 is used for light-guiding layer 13, urethane acrylate and the like having a refractive index of 1.52 is preferably used for synthetic resin 12A. Thus, light that has passed through base material 11 or light-guiding layer 13 enters synthetic resin 12A easily. Note here that the refractive indices of base material 11, light-guiding layer 13 and light-emitting portion 12 are not necessarily limited to the above-mentioned numeric values. That is to say, the refractive index of synthetic resin 12A is preferably substantially the same as or somewhat higher than the refractive indices of base material 11 and light-guiding layer 13. Light-emitting portion 12 only needs to include synthetic resin 12A and inorganic oxide particles 12B dispersed in synthetic resin 12A and having a refractive index higher than that of synthetic resin 12A. Thus, the refractive index of light-emitting portion 12 may be not less than the refractive indices of base material 11 and light-guiding layer 13. Even when the refractive index of synthetic resin 12A is lower than the refractive index of light-guiding layer 13, light-emitting portion 12 can emit light. However, it is preferable that the refractive index of synthetic resin 12A is substantially the same as or somewhat higher than the refractive index of light-guiding layer 13. Furthermore, similarly, even when the refractive index of base material 11 is lower than the refractive index of light-guiding layer 13, light-emitting portion 12 can emit light. However, it is preferable that the refractive index of base material 11 is substantially the same as or somewhat higher than the refractive index of light-guiding layer 13.

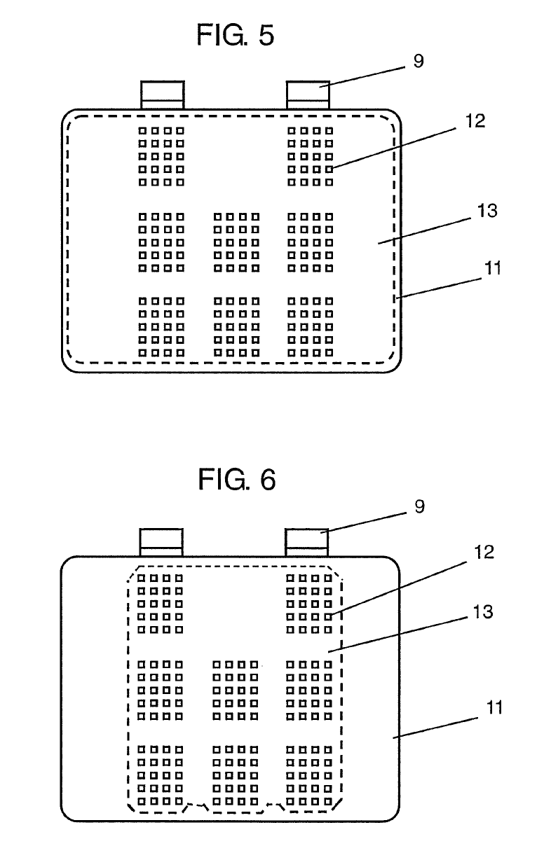

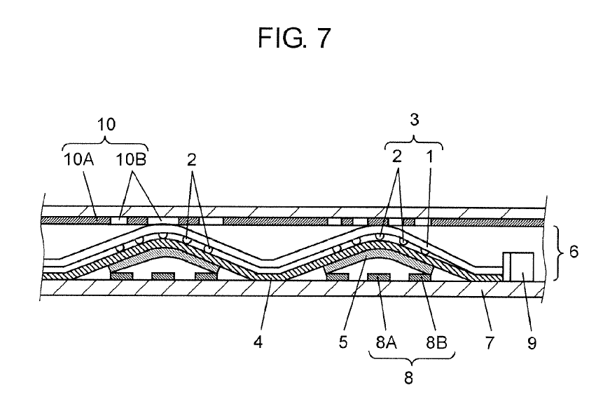

FIG. 5 is a schematic top view of a switch in accordance with the exemplary embodiment of the present invention. FIG. 6 is a schematic top view of another switch in accordance with the exemplary embodiment of the present invention. As shown in FIG. 5, it is preferable that light-guiding layer 13 is provided on the entire surface of the lower surface of base material 11 in a uniform thickness, but as shown in FIG. 6, portions on which light-guiding layer 13 is not formed may be formed partially. In this case, however, it is preferable that light-guiding layer 13 is formed such that light of light-emitting element 9 can enter light-emitting portion 12.

Furthermore, in this exemplary embodiment, light-emitting portion 12 is formed by dispersing inorganic oxide particles 12B in synthetic resin 12A. However, even when inorganic oxide particles 12B are not dispersed in synthetic resin 12A, light can be scattered or reflected by making the refractive index of light-emitting portion 12 not less than the refractive indices of base material 11 and light-guiding layer 13 and by forming light-emitting portions 12 in a convex shape. However, it is preferable that inorganic oxide particles 12B are dispersed because light is further scattered or reflected.

In the above description, a configuration in which light-emitting portion 12 is formed by dispersing inorganic oxide particles 12B such as titanium oxide and barium titanate in synthetic resin 12A is described. That is to say, light-emitting portion 12 is formed by dispersing inorganic particles whose refractive index is higher than that of synthetic resin 12A in synthetic resin 12A. However, light-emitting portion 12 may be formed by dispersing resin filler such as polyester, acryl and epoxy having a higher refractive index than that of synthetic resin 12A in synthetic resin 12A.

Furthermore, as shown in a sectional view of FIG. 4, a plurality of light-emitting portions 12 may be also provided on the lower surface of light-guiding layer 13 below the plurality of light-emitting portions 12 on the lower surface of base material 11. Thus, display portion 10B can be illuminated more brightly.

That is to say, when the light of light-emitting element 9, which enters base material 11 and light-guiding layer 13, is scattered by light-emitting portions 12 located in a middle portion between base material 11 and light-guiding layer 13 and by light-emitting portions 12 on the lower surface, intensity is more increased and thus bright illumination can be carried out. With this configuration, light-emitting portion 12 located in the middle portion, and light-emitting portion 12 on the lower surface can be disposed such that they are overlapped to each other in the up-and-down direction. Consequently, the degree of freedom in setting arrangement position of each light-emitting portion 12 is increased. Note here that a light-guiding layer covering light-emitting portions 12 on the lower surface may be further provided.

In this exemplary embodiment, convex light-emitting portions 12 are formed on the lower surface of base material 11, but the shape of light-emitting portions 12 may not be a convex shape. For example, concave-shaped light-emitting portions may be formed. That is to say, concave portions may be provided on the lower surface of base material 11 and light-emitting portions 12 may be formed in the concave portions.

Furthermore, light-emitting portions 12 are formed on the lower surface of base material 11 by printing. However, a plurality of light-emitting portions 12 may be provided on the upper surface of base material 11, and light-guiding layer 13 may be formed on the upper surface of base material 11 so as to cover light-emitting portions 12. Furthermore, light-emitting portions 12 can be formed by various methods other than printing. Examples of the methods include attaching, ink jet printing, laser processing, press working, molding, and the like.

Furthermore, a configuration is described in which base sheet 4 on the lower surface of which a plurality of movable contacts 5 are attached is attached on the lower surface of light-guiding sheet 14. However, with a configuration in which base sheet 4 is not provided, and a plurality of movable contacts 5 are directly attached on the lower surface of light-guiding sheet 14, the number of whole components can be reduced, so that movable contact body 16 and a switch can be formed more simply and more reasonably. That is to say, light-guiding layer 13 and movable contact 5 may be formed such that they face each other indirectly via base sheet 4, and they may be formed such that they face each other directly without including base sheet 4 therebetween.

Furthermore, in the above description, fixed contacts 8 include a circular-shaped center fixed contact 8A and a horseshoe-shaped or ring-shaped outer fixed contact 8B surrounding center fixed contact 8A. However, the configuration of fixed contacts 8 is not necessarily limited to this configuration. Any configurations may be employed as long as two fixed contacts are provided on wiring board 7 such that they are electrically connected to each other via movable contact 5 when movable contact 5 is reversed. That is to say, two fixed contacts may be provided in a portion in which movable contact 5 is disposed on wiring board 7, and the shape is not particularly limited. For example, two fixed contacts are disposed in the vicinity of the position facing the center of movable contact 5, and fixed contacts are electrically connected to each other with the center part of movable contact 5 when movable contact 5 is reversed.

Furthermore, in this exemplary embodiment, base material 11 and light-guiding layer 13 are formed separately. However, base material 11 and light-guiding layer 13 may be formed in one layer, and light-emitting portions 12 may be disposed in the layer. A plurality of light-emitting portions may be unevenly distributed as shown in FIG. 5.

In this way, light-guiding sheet 14 of this exemplary embodiment includes film-shaped light-transmitting base material 11, a plurality of light-emitting portions 12 formed on base material 11, and light-transmitting light-guiding layer 13 covering the plurality of light-emitting portions 12. Thus, the light of light-emitting element 9 enters not only from base material 11 but also from light-guiding layer 13, and an amount of light scattered and reflected by light⁻emitting portion 12 is increased. Therefore, movable contact body 16 using light-guiding sheet 14 enables bright illumination and enables easy-to-see and easy operation.

Furthermore, light-emitting portion 12 is formed also on the lower surface of light-guiding layer 13 below light-emitting portion 12, thereby enabling brighter illumination.

### INDUSTRIAL APPLICABILITY

A light-guiding sheet and a movable contact body using the same in accordance with the present invention enables bright and easy-to-see illumination, and enables easy operations. Therefore, they are useful mainly for operations of electronic apparatuses.

### REFERENCE MARKS IN DRAWINGS

4 base sheet
5 movable contact
7 wiring board
8 fixed contact
8A center fixed contact
8B outer fixed contact
9 light-emitting element
10 display sheet
10A coated portion
10B display portion

01, 11 base material
2, 12 light-emitting portion
12A synthetic resin
12B inorganic oxide particle
13 light-guiding layer
3, 14 light-guiding sheet
15 separator
6, 16 movable contact body

1. A light-guiding sheet comprising:
a film-shaped light-transmitting base material;
a plurality of light-emitting portions formed on the base material; and
a light-transmitting light-guiding layer covering the plurality of light-emitting portions,
wherein the light-emitting portions allow light from the base material and the light-guiding layer to be scattered.

2. The light-guiding sheet of claim 1, wherein the light-emitting portions are formed in a convex shape on the base material.

3. The light-guiding sheet of claim 1, wherein a refractive index of the light-emitting portion is not less than refractive indices of the base material and the light-guiding layer.

4. The light-guiding sheet of claim 1, further comprising a light-emitting portion on a surface at an opposite side to a surface covering the light-emitting portions of the light-guiding layer.

5. The light-guiding sheet of claim 1, wherein the light-emitting portion includes resin, and particles dispersed in the resin and having a refractive index higher than that of the resin.

6. The light-guiding sheet of claim 5, wherein the refractive index of the resin is substantially equal to or greater than the refractive indices of the base material and the light-guiding layer.

7. The light-guiding sheet of claim 5, wherein a diameter of each of the particles is not less than 0.4 μm and not more than 1.5 μm.

8. The light-guiding sheet of claim 1, wherein the refractive index of the light-guiding layer is substantially equal to or smaller than the refractive indices of the base material and the light-guiding layer.

9. A movable contact body comprising:
a light-guiding sheet which includes:
a film-shaped light-transmitting base material;
a plurality of light-emitting portions formed on the base material; and
a light-transmitting light-guiding layer covering the plurality of light-emitting portions; and
a dome-shaped electrically conductive movable contact,
wherein the light-emitting portions allow light from the base material and the light-guiding layer to be scattered, and
the light-guiding layer confronts the movable contact directly or indirectly.
